(19) United States
(12) Patent Application Publication
(10) Pub. No.: US 2021/0138721 A1
(43) Pub. Date: May 13, 2021

(54) PRINTED STRUCTURE WITH METALLIC APPEARANCE

(71) Applicant: SIGNIFY HOLDING B.V., EINDHOVEN (NL)

(72) Inventors: RIFAT ATA MUSTAFA HIKMET, EINDHOVEN (NL); STEFAN WILLI JULIUS GRUHLKE, BAESWEILER (DE); LOES JOHANNA MATHILDA KOOPMANS, SOERENDONK (NL)

(21) Appl. No.: 17/045,881

(22) PCT Filed: Apr. 9, 2019
(86) PCT No.: PCT/EP2019/058931

§ 371 Date: Oct. 7, 2020

(30) Foreign Application Priority Data
Apr. 16, 2018 (EP) 18167508.3

(51) Int. Cl. B29C 64/118; B33Y 70/10; B33Y 10/00; B33Y 80/00

(52) U.S. Cl. CPC B29C 64/118; B33Y 70/10; B29L 2031/7472; B33Y 80/00; B29K 2995/003; B33Y 10/00

(57) ABSTRACT

The invention provides a method for 3D printing a 3D item (1), the method comprising (i) providing 3D printable material (201) comprising particles (410) embedded in the 3D printable material (201), wherein the particles (410) are reflective for at least part of the visible light, wherein the particles (410) have a particle length (L1), a particle height (L2), and an aspect ratio AR defined as the ratio of the particle length (L1) and the particle height (L2), wherein AR>5, and (ii) layer-wise depositing the 3D printable material (201) to provide the 3D item (10) with layers (322) of the 3D printed material (202) with a layer height (H) and a layer width (W), and wherein the 3D printable material (201) has a particle concentration C selected from the range of 0.001-30 vol. % of the particles (410) relative to the total volume of the 3D printable material (201).

### FIELD OF THE INVENTION

The invention relates to a method for manufacturing a 3D (printed) item. The invention also relates to the 3D (printed) item obtainable with such method. Further, the invention relates to a lamp or luminaire including such 3D (printed) item.

### BACKGROUND OF THE INVENTION

The use of a thermoplastic polymer comprising a particulate filler for preparing 3D articles is known in the art. WO2017/040893, for instance, describes a powder composition, wherein the powder composition comprises a plurality of thermoplastic particles characterized by a bimodal particle size distribution, and wherein the powder composition may further comprise a particulate filler, antioxidant, heat stabilizer, light stabilizer, ultraviolet light stabilizer, ultraviolet light absorbing additive, near infrared light absorbing additive, infrared light absorbing additive, plasticizer, lubricant, release agent, antistatic agent, anti-fog agent, antimicrobial agent, colorant, laser marking additive, surface effect additive, radiation stabilizer, flame retardant, anti-drip agent, fragrance, fiber, or a combination comprising at least one of the foregoing, preferably a colorant or a metal particulate. This document further describes a method of preparing a three-dimensional article, the method comprising powder bed fusing the powder composition to form a three-dimensional article.

### SUMMARY OF THE INVENTION

Within the next 10-20 years, digital fabrication will increasingly transform the nature of global manufacturing. One of the aspects of digital fabrication is 3D printing. Currently, many different techniques have been developed in order to produce various 3D printed objects using various materials such as ceramics, metals and polymers. 3D printing can also be used in producing molds which can then be used for replicating objects.

For the purpose of making molds, the use of polyjet technique has been suggested. This technique makes use of layer by layer deposition of photo-polymerisable material which is cured after each deposition to form a solid structure. While this technique produces smooth surfaces the photo curable materials are not very stable and they also have relatively low thermal conductivity to be useful for injection molding applications.

The most widely used additive manufacturing technology is the process known as Fused Deposition Modeling (FDM). Fused deposition modeling (FDM) is an additive manufacturing technology commonly used for modeling, prototyping, and production applications. FDM works on an “additive” principle by laying down material in layers; a plastic filament or metal wire is unwound from a coil and supplies material to produce a part. Possibly, (for thermoplastics for example) the filament is melted and extruded before being laid down. FDM is a rapid prototyping technology. Other terms for FDM are “fused filament fabrication” (FFF) or “filament 3D printing” (FDP), which are considered to be equivalent to FDM. In general, FDM printers use a thermoplastic filament, which is heated to its melting point and then extruded, layer by layer, (or in fact filament after filament) to create a three-dimensional object. FDM printers are relatively fast and can be used for printing complicated object.

FDM printers are relatively fast, low cost and can be used for printing complicated 3D objects. Such printers are used in printing various shapes using various polymers. The technique is also being further developed in the production of LED luminaires and lighting solutions.

It appears to be desirable to have objects with a metallic look. In the context of the present invention, the term “metallic look” should be interpreted as referring to an appearance that resembles that of a metal object, specifically resembling the light reflective properties of a metal object.

Hence, it is an aspect of the invention to provide an alternative 3D printing method and/or 3D (printed) item, which preferably further at least partly obviate(s) one or more of above-described drawbacks. The present invention may have as object to overcome or ameliorate at least one of the disadvantages of the prior art, or to provide a useful alternative.

For this purpose, e.g. polymers provided with flake-like and/or coin-like particles can be used. These can for instance be based on metallic flakes and/or inorganic particles coated with metals. Flake like substrates may also be provided with inorganic multi layers. However, it appears that the metallic look of the side face of such object can essentially only be obtained under specific conditions.

Hence, in a first aspect the invention provides a method for 3D printing a 3D item, the method comprising (i) providing a 3D printable material, and (ii) layer-wise depositing (during a printing stage) the 3D printable material to provide the 3D item with layers of the 3D printed material.

The 3D printable material comprises particles embedded in the 3D printable material at a particle concentration.

The particles have a particle length (L1), a particle height (L2), a particle width (L3), and a first aspect ratio AR defined as the ratio of the particle length (L1) and the particle height (L2). As indicated below, these dimensions may be defined in relation to a smallest cuboid containing the particle.

The layers of the 3D printed material have a layer height (H), a layer width (W) and a layer aspect ratio defined as the ratio of the layer width (W) and the layer height (H).

In specific embodiments, the first aspect ratio AR≥2, even more especially, AR≥5. As indicated above, the first aspect ratio AR is defined as L1/L2. Further, especially in embodiments L1≈L3.

When the layer aspect ratio (W/H) in the printed object is larger than 2 (W/H>2), then the particle concentration needs to be in the range 4-13 vol. %.

When the layer aspect ratio layer (W/H) in the printed object is 1≤W/H≤2, then the particle concentration can be in the range 0.004-13 vol. %, but especially in the range of 0.004-4 vol. %. However, in the latter embodiment the increase of concentration above about 4 vol. % does essentially not lead to increase in reflectivity thus the particle concentration is especially in the range 0.004-4 vol. %.

With such method, it is possible to print 3D items that have 3D printed material that has a relative reflective appearance, even at the (ribbed) side faces. As also further discussed below, such item may be used for decorative purposes, but may also be a functional component, such as e.g. part of a lamp or luminaire, like (a part of) a shade or of a reflective surface (for beam shaping of a beam of light of the lamp or luminaire).

Especially, the particle concentration (0.001-60 vol. %, such as 0.004-30 vol. %, like especially 0.004-13 vol. %)) scales with about the inverse of the layer height (0.05-5 mm), or, the layer height scales with about the inverse of the particle concentration. Hence, at 60 vol. % of the particles the layer height may be about 0.05 mm, and at about 0.001 vol. % of the particles, the layer height may be about 5 mm. Especially, at 30 vol. % of the particles the layer height may be about 0.05 mm, and at about 0.004 vol. % of the particles, the layer height may be about 5 mm. Like, especially at 13 vol. % of the particles the layer height may be about 0.05 mm, and at about 0.004 vol. % of the particles, the layer height may be about 5 mm.

In specific embodiments when printing layers with relative large layer heights, such as about 0.8-3 mm, the particle concentration can thus be relatively low, such as e.g. in the range of about 0.004-4 vol. %, whereas when the layer heights are relatively small, such as in the range of about 0.05-0.8 mm, the particle concentration may be relatively high, such as e.g. in the range of about 4-13 vol. %.

As indicated above, the 3D printable material comprises in the range of 0.001-60 vol. %, especially 0.004-30 vol. %, even more especially 0.004-13 vol. % of the particles, relative to the total volume of the 3D printable material (including particles).

In addition to these particles, the 3D printable material may thus comprise further particulate material (as indicated also below), in total to an amount of 60 vol. %, more especially up to in total 30 vol. %, relative to the total volume of the printable material (including the reflective particles and optional further particles), even more especially up to a total of about 13 vol. %.

Further, the concentration of the (reflective) particles may depend upon the layer height and layer width of the 3D printed material. Hence, the deposited filament may have a layer height H) and layer width W. It appears that for a ratio of the width/layer height (W/H) in the printed object is within the range of 1≤W/H≤2, then the particle concentration can be selected from the 0.004-13%. However, as indicated above the increase of concentration above 4 vol. % does not lead to increase in reflectivity thus the particle concentration is especially in the range 0.004-4 vol. %. For ratios of the layer height to the layer width W/H>2, then the concentration of the particles may especially be selected from the range of 4-13 vol. %.

Therefore, when a ratio layer width (W) to layer height (H) in the 3D printed material is to comply with W/H>2, then the particle concentration is selected from the range of 4-13 vol. %, and when the ratio layer width (W) to layer height (H) in the 3D printed material is to comply with 1≤W/H≤2, then the particle concentration is selected from the range 0.004-4%.

Especially, essentially flat particles may be applied, such as coin shaped particles or flake like shaped particles. The particles may be regularly shaped or may be irregularly shaped. Also a combination of differently shaped particles may be provided. Therefore, in embodiments the particles have shapes selected from one or more of coin shapes and flake shapes.

In specific embodiments, the particles (410) have a second aspect ratio AR2 of the particle width (L3) and the particle height (L2), wherein AR2≥5.

Especially, AR≥10, such as AR≥20. Further, especially AR2≥5, such as AR2≥10, like AR2≥20.

In embodiments, 1≤L1/L3≤4, like 1≤L1/L3≤3, like especially 1≤L1/L3≤2. Hence, the length and the width may be about the same, whereas the height is substantially smaller than the length or the width. Therefore, in embodiments L1≈L3. When the length and width are unequal, then (by definition) L1>L3. Hence, the length may herein also be indicated as “longest dimension”.

The particles as defined above are herein also indicated as “reflective particles”. These particles are especially flake-like or coin-like. Hence, these particles may also be indicated as “flakes” or “reflective flakes”, etc.

In yet other embodiments, the particles have the shape of a coin. Hence, these particles may also be indicated as “coins”, “dollars” or “reflective coins” or “reflective dollar”, etc.

Hence, the particles are relatively flat (thin), with a small height, and relatively large lengths and widths.

In embodiments, the particles comprise one or more of glass and mica. In yet other embodiments, the particles comprise a metal. Hence, particles may be made a metal such as aluminum and copper. In embodiments, the particles may be coated with a reflective material. Particles may have a coating, wherein the coating comprises one or more of a metal coating and a metal oxide coating.

The particles are reflective for at least part of the visible light, i.e. light having one or more wavelengths selected from the range of 380-780 nm.

The flakes, as mentioned herein, may have any shape. An example of particles with a high aspect ratio is cornflake particles. Cornflake particles are high aspect ratio flakes with ragged edges and a cornflake-like appearance. Cornflake particles may have aspect ratios in the range of 10-1.000. In specific embodiments, the particles may have the shape of a flake, such as a “silver dollar” shape.

In specific embodiments, the particles may irregularly be shaped.

In specific embodiments, the particles may comprise pieces of broken glass (having the herein defined dimensions)

The particles can be mica particles or glass particles, especially mica particles or glass particles with a coating. In specific embodiments, the particles comprise glass particles having a coating. It appears that such particles have better properties, such as in terms of reflection, especially specular reflection, than metal flakes. Such particles tend to provide a relative higher diffuse reflection.

However, especially the glass or mica particles, especially the glass particles, may have a coating comprises one or more of a metal coating and a metal oxide coating.

Metal coatings may e.g. be selected from aluminum, silver, gold, etcetera. Metal oxide coatings may e.g. include tin oxide, titanium oxide, etcetera. Magnesium oxide and/or aluminum oxide may also be applied. Therefore, in specific embodiments the particles comprise glass flakes. In further specific embodiments, the particles comprise silver or aluminum coated glass particles. In specific embodiments, also combinations of different type of particles may be used. Especially, the particles comprise one or more of a silver coating and an aluminum coating.

Particles may also be so called glitter particles. Glitters are made by cutting sheets of polymer into small pieces. The glitters may also comprise coatings.

A metal coating may especially have an essentially specular reflective coating. Hence, especially a metal coating may be applied.

The particles may comprise a single material or the particles may comprise different types of materials.

The particles may have a unimodal particle size distribution or a polymodal size distribution.

Especially, in embodiments for at least part of the total number of particles the particle length (L1) is selected from the range of 5-200 μm, such as 5-100 μm, more especially the particle length (L1) is selected from the range of 10-100 μm.

Further, in embodiments the particle height (L2) may be selected from the range of 0.1-100 μm, even more especially the particle height (L2) may be selected from the range of 0.1-20 μm. Especially, such particles may provide the metallic look within the described layer height.

Especially, in embodiments for at least part of the total number of particles a particle width (L3) is selected from the range of 5-200 μm, such as 5-100 μm, more especially the particle width (L3) is selected from the range of 10-100 μm.

In yet further specific embodiments, at least 50 wt % of the particles have the particle length (L1) selected from the range of 5-200 μm, such as 5-100, μm, more especially 10-100 μm.

In yet further specific embodiments, at least 50 wt % of the particles have the particle height (L2) selected from the range of 0.1-100 μm, more especially 0.1-20 μm.

In yet further specific embodiments, at least 50 wt % of the particles have the particle width (L3) selected from the range of 5-200 μm, such as 5-100, μm, more especially 10-100 μm.

Further, in embodiments, for at least 50 wt % of the particles applies AR≥2, even more especially, AR≥5. Further, in embodiments, for at least 50 wt % of the particles applies AR2≥2, even more especially, AR2≥5.

For irregular shaped particles, but also for regular shaped articles, for the sake of easiness, the smallest rectangular cuboid (rectangular parallelepiped) enclosing the (irregular shaped) particle may be used to define the length, width and height. Hence, the term “first dimension” especially refers to the length of the smallest rectangular cuboid (rectangular parallelepiped) enclosing the irregular shaped particle.

Herein, the terms “first dimension” or “longest dimension” especially refers to the particle length. Especially, a largest dimension is the dimension in the plane of the particle. Herein, the terms “second dimension” or “shortest dimension” especially refers to the thickness of the particles. Herein, the terms “third dimension” especially refers to the width of the particles.

The aspect ratios, as indicted above, refer to the particles including an optional coating of the particles. The phrase “coating of the particles” especially refers to a coating on an individual particle, i.e. a coating enclosing a single particle. Hence, also the term “particle coating” may be used. The coating may enclose the particle entirely or only a part of the particle. The particles of a subset of the total number of particles may include a particle coating and anther subset of the total number of particles may not include a particle coating. Further, the aspect ratios indicated above may refer to a plurality of particles having different aspect ratios. Hence, the particles may be substantially identical, but the particles in the coating may also mutually differ, such as two or more subsets of particles, wherein within the subsets the particles are substantially identical.

The particles may thus mutually differ. For instance, the particles may have a distribution of the sizes of one or more of the particle length, the particle height, and an intermediate length. Therefore, in average, the particles will have dimensions as described herein. For instance, at least 50 wt % of the particles comply with the herein indicated dimensions (including ratios), such as at least 75 wt %, like at least 85 wt %.

The polymeric printable material, i.e. the continuous phase, is especially not cross-linked, but may especially comprise thermoplastic material. In specific embodiments, the 3D printable material may comprise one or more of acrylonitrile butadiene styrene, polystyrene, polycarbonate, modified PC with higher Tg (e.g. Apec from Covestro), polyethylene terephthalate, polymethylmethacrylate, polyethylene, polypropylene, and copolymers of two or more of these.

As indicated herein, the 3D item is especially generated by layer-wise deposition of layers. When referring to the concentration of the particles during deposition of the filaments or after deposition of the filaments, the concentration especially refers to at least part of such filament, or at least part of the deposited layer. Hence, the concentration of the particles may vary over the length of the filament or may vary over a length of a layer, or differ between layers. It is even possible that there are layers without particles and layers with particles. The smallest (integral) volume for which the concentration applies is especially at least 1 cm³, such as at least 2 cm³, like at least 5 cm³. Of course, this may be a relative extended volume, as the height and width of the layers are in general relatively small.

Though the particles are embedded in the material, this does not exclude that a subset of the particles may partially protrude from the 3D printable material. This may also apply to the 3D printed material. Hence, the 3D printed material may have roughness as a result of particles partially extending from the (polymeric) 3D printed material (even though a smoothening of the surface of the 3D printed item may lead to an essentially smooth surface). This may contribute to a reflective appearance of the product.

The printable material may thus comprise two phases. The printable material may comprise a phase of printable polymeric material, especially thermoplastic material (see also below), which phase is especially an essentially continuous phase. In this continuous phase of thermoplastic material polymer additives such as one or more of antioxidant, heat stabilizer, light stabilizer, ultraviolet light stabilizer, ultraviolet light absorbing additive, near infrared light absorbing additive, infrared light absorbing additive, plasticizer, lubricant, release agent, antistatic agent, anti-fog agent, antimicrobial agent, colorant, laser marking additive, surface effect additive, radiation stabilizer, flame retardant, anti-drip agent may be present. The printable material further comprises particulate material, i.e. particles embedded in the printable polymeric material, which particles form a substantially discontinuous phase. The amount of particles in the total mixture is especially not larger than 60 vol. %, relative to the total volume of the printable material (including the particles) especially in applications for reducing thermal expansion coefficient. For optical and surface related effect amount of particles in the total mixture is equal to or less than 30 vol. %, like equal to or less than 13 vol. %, relative to the total volume of the printable material (including the particles). Hence, the 3D printable material especially refers to a continuous phase of essentially thermoplastic material, wherein the particles of cross-linked polymeric material, and optionally other particles, are embedded. Likewise, the 3D printed material especially refers to a continuous phase of essentially thermoplastic material, wherein the particles of cross-linked polymeric material, and optionally other particles, are embedded.

Herein below, when it is referred to particles, it is referred to the reflective particles, unless indicated otherwise or clear from the context. Hence, the printable material (including particles) is herein also indicated as “printable material”. However, the term “3D printable material” especially refers to the continuous phase of thermoplastic material; when embodiments of the particles are described, it is especially referred to “the particles”. Hence, the thermoplastic material (that provides the continuous phase) may be 3D printable, especially FDM printable per se, whereas the particles as such may essentially not be 3D printable, but may only be printable as they embedded in the thermoplastic (essentially (chemically) non-crosslinked) 3D printable material.

For optical applications, but also for non-optical applications, it may be desirable that the 3D printable material, i.e. the thermoplastic material, is light transmissive.

As indicated above, the method comprises layer-wise depositing (during a printing stage) 3D printable material. Herein, the term “3D printable material” refers to the material to be deposited or printed, and the term “3D printed material” refers to the material that is obtained after deposition. These materials may be essentially the same, as the 3D printable material may especially refer to the material in a printer head or extruder at elevated temperature and the 3D printed material refers to the same material, but in a later stage when deposited. The 3D printable material is printed as a filament and deposited as such. The 3D printable material may be provided as filament or may be formed into a filament. Hence, whatever starting materials are applied, a filament comprising 3D printable material is provided by the printer head and 3D printed. Herein, the term “3D printable material” may also be indicated as “printable material. The term “polymeric material” may in embodiments refer to a blend of different polymers, but may in embodiments also refer to essentially a single polymer type with different polymer chain lengths. Hence, the terms “polymeric material” or “polymer” may refer to a single type of polymers but may also refer to a plurality of different polymers. The term “printable material” may refer to a single type of printable material but may also refer to a plurality of different printable materials. The term “printed material” may refer to a single type of printed material but may also refer to a plurality of different printed materials.

The filament with 3D printable material is thus converted into layers of 3D printed material. In general, the filament from the printer nozzle may have a circular cross-section, whereas the layers are flattened, such as due to pressure of the nozzle during printing. Hence, the deposited layers of 3D printed material in especially have a width that is at least equal, but in general larger, than the height of the deposited layers. Hence, basically 3D printable material, optionally in the form of a filament, may be provided to the printer head. The 3D printable material is driven through the printer nozzle to provide a filament of 3D printable material, which is deposited in layers. Hence, upon deposition the filament of 3D printable material becomes a layer of 3D printed material.

Due to the layer-wise deposition, 3D printed filaments are deposited one on another. Hence, the term “height of the layer” and similar terms especially refer to the height of a layer in a direction perpendicular to a receiver item. It is thus the height of a (characteristic) rib. The term “width of the layer” and similar terms especially refer to the width of the parallel to the receiver item. It is thus the width of such (characteristic) rib. The height and width refer to the height of a single layer, such as which is the result of 3D printing part of the filament on the receiver item.

Hence, the term “3D printable material” may also refer to a combination of two or more materials. In general, these (polymeric) materials have a glass transition temperature T_{g} and/or a melting temperature Tₘ. The 3D printable material will be heated by the 3D printer before it leaves the nozzle to a temperature of at least the glass transition temperature, and in general at least the melting temperature. Hence, in a specific embodiment the 3D printable material comprises a thermoplastic polymer having a glass transition temperature (T_{g}) and/or a melting point (Tₘ), and the printer head action comprises heating the 3D printable material above the glass transition and if it is a semi-crystalline polymer above the melting temperature. In yet another embodiment, the 3D printable material comprises a (thermoplastic) polymer having a melting point (Tₘ), and the printer head action comprises heating the 3D printable material to be deposited on the receiver item to a temperature of at least the melting point. The glass transition temperature is in general not the same thing as the melting temperature. Melting is a transition which occurs in crystalline polymers. Melting happens when the polymer chains fall out of their crystal structures, and become a disordered liquid. The glass transition is a transition which happens to amorphous polymers; that is, polymers whose chains are not arranged in ordered crystals, but are just strewn around in any fashion, even though they are in the solid state. Polymers can be amorphous, essentially having a glass transition temperature and not a melting temperature or can be (semi) crystalline, in general having both a glass transition temperature and a melting temperature, with in general the latter being larger than the former.

As indicated above, the invention thus provides a method comprising providing a filament of 3D printable material and printing (during a printing stage) said 3D printable material on a substrate, to provide said 3D item.

Materials that may especially qualify as 3D printable materials may be selected from the group consisting of metals, glasses, thermoplastic polymers, silicones, etc. Especially, the 3D printable material comprises a (thermoplastic) polymer selected from the group consisting of ABS (acrylonitrile butadiene styrene), Nylon (or polyamide), Acetate (or cellulose), PLA (poly lactic acid), terephthalate (such as PET polyethylene terephthalate), acrylic (polymethylacrylate, Perspex, polymethylmethacrylate, PMMA), polypropylene (or polypropene), polystyrene (PS), low density polyethylene (LDPE), High density polythene (HDPE)), PVC (polyvinyl chloride) Polychloroethene, a polyamide, other polyesters such as Polycarbonate (PC), sulfide containing polymers such as polysulfone, thermoelastic elastomers such as polyurethanes and copolymers of PET with polyethylyene glycol. Specific examples are also indicated above.

Especially, the printable material per se is light transmissive, more especially optically transparent. PPMA, PC, amorphous PET, PS and co-polyesters of two or more thereof are suitable polymers. Hence, especially polymeric materials may be applied that are at least partially transmissive for visible light. For instance, the polymeric material may be transparent to light (assuming the particles are not (yet) available).

The printable material is printed on a receiver item. Especially, the receiver item can be the building platform or can be comprised by the building platform. The receiver item can also be heated during 3D printing. However, the receiver item may also be cooled during 3D printing.

The phrase “printing on a receiver item” and similar phrases include amongst others directly printing on the receiver item, or printing on a coating on the receiver item, or printing on 3D printed material earlier printed on the receiver item. The term “receiver item” may refer to a printing platform, a print bed, a substrate, a support, a build plate, or a building platform, etc. Instead of the term “receiver item” also the term “substrate” may be used. The phrase “printing on a receiver item” and similar phrases include amongst others also printing on a separate substrate on or comprised by a printing platform, a print bed, a support, a build plate, or a building platform, etc. Therefore, the phrase “printing on a substrate” and similar phrases include amongst others directly printing on the substrate, or printing on a coating on the substrate or printing on 3D printed material earlier printed on the substrate. Here below, further the term substrate is used, which may refer to a printing platform, a print bed, a substrate, a support, a build plate, or a building platform, etc., or a separate substrate thereon or comprised thereby.

Layer by layer printable material is deposited, by which the 3D printed item is generated (during the printing stage). The 3D printed item may show a characteristic ribbed structures (originating from the deposited filaments). However, it may also be possible that after a printing stage, a further stage is executed, such as a finalization stage. This stage may include removing the printed item from the receiver item and/or one or more post processing actions. One or more post processing actions may be executed before removing the printed item from the receiver item and/or one more post processing actions may be executed after removing the printed item from the receiver item. Post processing may include e.g. one or more of polishing, coating, adding a functional component, etc. Post-processing may include smoothening the ribbed structures, which may lead to an essentially smooth surface.

The method may especially be applied using a fused deposition modeling 3D printer, wherein the fused deposition modeling 3D printer comprises a printer head comprising a printer nozzle. Especially, the printer nozzle may have a circular cross-section that is larger than the largest dimension or length (L1). The equivalent circular diameter (or ECD) of an irregularly shaped two-dimensional shape is the diameter of a circle of equivalent area. For instance, the equivalent circular diameter of a square with side a is 2*a*SQRT(1/π).

A 3D printable material that may be used in the herein described method has particles embedded therein, wherein the particles are reflective for at least part of the visible light, wherein the particles have a particle length (L1), a particle height (L2), and a first aspect ratio AR defined as the ratio of the particle length (L1) and the particle height (L2), and wherein especially the 3D printable material has a particle concentration C in the range of 0.001-60 vol. % of the particles relative to the total volume of the 3D printed material.

Some specific examples in relation to the 3D printable material have already been elucidated below when discussing the method. Below, some specific examples in relation to the 3D printable material are discussed in more detail.

In specific examples, in the fused deposition modelling 3D printable material at least 50 vol. % of the particles have the particle length (L1) selected from the range of 5-200 μm, especially 5-100, even more especially 10-100 μm, and the particle height (L2) selected from the range of 0.1-20 μm. Further, especially the(se) particles comprise one or more of a silver coating and an aluminum coating. In yet further examples, the 3D printable material has a particle concentration C in the range of 0.001-30 vol. %, even more especially 0.04-13 vol. %, of the particles relative to the total volume of the 3D printed material.

As indicated above, the concentration may vary over the length of a filament comprising the 3D printable material. In general however, the concentration will be essentially even over the length of the filament.

As indicated above, in specific examples, AR≥2, with AR being defined as L1/L2. In specific examples, the particles have a second aspect ratio AR2 of the particle width (L3) and the particle height (L2), wherein AR2≥5. Especially, AR≥10, such as AR≥20. Further, especially AR2≥5, such as AR2≥10.

In examples, 1≤L1/L3≤4, like 1≤L1/L3≤3, like especially 1≤L1/L3≤2. Hence, the length and the width may be about the same, whereas the height is substantially smaller than the length or the width. Therefore, in examples L1≈L3.

Above, the particles were described in relation to the method. However, the examples of the particles as indicated above, apply as well to the 3D printable material as well as to the 3D printed material. Hence, especially, in examples for at least part of the total number of particles the particle length (L1) is selected from the range of 5-200 μm, such as 5-100 μm, more especially the particle length (L1) is selected from the range of 10-100 μm.

Further, in examples the particle height (L2) may be selected from the range of 0.1-100 μm, even more especially the particle height (L2) may be selected from the range of 0.1-20 μm. Especially, such particles may provide the metallic look within the described layer height. Especially, in embodiments for at least part of the total number of particles a particle width (L3) is selected from the range of 5-200 μm, such as 5-100 μm, more especially the particle width (L3) is selected from the range of 10-100 μm.

In yet further specific examples, at least 50 wt % of the particles have the particle length (L1) selected from the range of 5-200 μm, such as 5-100, μm, more especially 10-100 μm.

In yet further specific examples, at least 50 wt % of the particles have the particle height (L2) selected from the range of 0.1-100 μm, more especially 0.1-20 μm.

In yet further specific examples, at least 50 wt % of the particles have the particle width (L3) selected from the range of 5-200 μm, such as 5-100, μm, more especially 10-100 μm.

Further, in examples, for at least 50 wt % of the particles applies AR≥2, even more especially, AR≥5.

Further, in examples, for at least 50 wt % of the particles applies AR2≥2, even more especially, AR2≥5.

Further, the invention relates to a software product that can be used to execute the method described herein. Instead of the term “software product” also the term “computer program product” may be applied.

The herein described method provides 3D printed items. Hence, the invention also provides in a further aspect a 3D printed item obtainable with the herein described method.

Especially, the invention provides a 3D item comprising 3D printed material (wherein the 3D printed material comprises a thermoplastic material) with particles embedded therein at a particle concentration, wherein the particles are reflective for at least part of the visible light, wherein the particles have a particle length (L1), a particle height (L2), and a first aspect ratio AR defined as the ratio of the particle length (L1) and the particle height (L2), and wherein the 3D item comprises layers of the 3D printed material with a layer height (H), a layer width (W) and a layer aspect ratio defined as the ratio of the layer width (W) and the layer height (H). The first aspect ratio AR≥5. The layer aspect ratio is larger than 2 and the particle concentration is in a range of 4-13 vol. % relative to the total volume of the 3D printable material (201), or the layer aspect ratio is equal to or smaller than 2 and equal to or larger than 1 and the particle concentration is in a range of 0.004-4% vol. % relative to the total volume of the 3D printable material (201).

Further, in specific embodiments the layer height (H) is selected from the range of 0.05-5 mm. Further, especially the 3D printed material has a particle concentration C in the range of 0.001-60 vol. %, especially 0.001-30 vol. %, of the particles relative to the total volume of the 3D printed material (in the respective layer).

The particles are embedded in the 3D printed material. However, a subset of the total number of particles may also be at the surface of the 3D printed material, and partially extend thereof. Hence, at least a part of the total number of particles is fully embedded in the printed material; a part of the total number of particles may be partly embedded in the printed material and may extend from the surface of the 3D printed material.

As indicated above, the smallest (integral) volume for which the concentration applies is especially at least 1 cm³, such as at least 2 cm³, like at least 5 cm³. Of course, this may be a relative extended volume, as the height and width of the layers are in general relatively small. Hence, the phrase “relative to the total volume of the 3D printed material” and similar phases, especially refer to relative to the total volume of the 3D printed material within at least part of a (3D printed) layer.

Some specific embodiments in relation to the 3D printed item have already been elucidated below when discussing the method. Below, some specific embodiments in relation to the 3D printed item are discussed in more detail.

As can be derived from the above, especially the 3D printed material comprises in the range of 0.001-60 vol. %, especially 0.001-30 vol. %, relative to the total volume of the 3D printed material. In addition to these particles, the 3D printed material may thus comprise further particulate material (as indicated above), in total to an amount of 60 vol. %, more especially up to in total 30 vol. % relative to the total volume of the printable material. Hence, in embodiments the 3D printed material comprises in the range of up to 60 vol. %, such as up to 30 vol. %, relative to the total volume of the 3D printed material.

Further, the concentration of the (reflective) particles may depend upon the layer height and layer width of the 3D printed material. Hence, the deposited filament may have a layer height H) and layer width W. It appears that for a ratio of the width/layer height (W/H) in the printed object is within the range of 1≤W/H≤2, then the particle concentration can be selected from the 0.004-13%.

However, as indicated above the increase of concentration above 4 vol. % does not lead to increase in reflectivity thus the particle concentration is especially in the range 0.004-4 vol. %. For ratios of the layer height to the layer width W/H>2, then the concentration of the particles may especially be selected from the range of 4-13 vol. %. Therefore, when a ratio layer width (W) to layer height (H) in the 3D printed material is to comply with W/H>2, then the particle concentration is selected from the range of 4-13 vol. %, and when the ratio layer width (W) to layer height (H) in the 3D printed material is to comply with 1≤W/H≤2, then the particle concentration is selected from the range 0.004-4%.

As indicated above, especially in embodiments for at least part of the total number of particles the particle length (L1) is selected from the range of 5-200 μm, such as 5-100 μm, more especially the particle length (L1) is selected from the range of 10-100 μm. Further, in embodiments the particle height (L2) may be selected from the range of 0.1-100 μm, even more especially the particle height (L2) may be selected from the range of 0.1-20 μm. Especially, such particles may provide the metallic look within the described layer height. Especially, in embodiments for at least part of the total number of particles a particle width (L3) is selected from the range of 5-200 μm, such as 5-100 μm, more especially the particle width (L3) is selected from the range of 10-100 μm. In yet further specific embodiments, at least 50 wt % of the particles have the particle length (L1) selected from the range of 5-200 μm, such as 5-100, μm, more especially 10-100 μm. In yet further specific embodiments, at least 50 wt % of the particles have the particle height (L2) selected from the range of 0.1-100 μm, more especially 0.1-20 μm. In yet further specific embodiments, at least 50 wt % of the particles have the particle width (L3) selected from the range of 5-200 μm, such as 5-100, μm, more especially 10-100 μm. Further, in embodiments, for at least 50 wt % of the particles applies AR≥2, even more especially, AR≥5. Further, in embodiments, for at least 50 wt % of the particles applies AR2≥2, even more especially, AR2≥5.

Further, in view of the reflectivity in embodiments the particles may be made of metals such as Al and copper, or comprise one or more of a silver coating and an aluminum coating. It is further also referred to the embodiments in relation to the method; see also above.

In specific embodiments, the 3D printed material comprises one or more of acrylonitrile butadiene styrene, polystyrene, polycarbonate, polyethylene terephthalate, polyethylene, polypropylene, polymethylmethacrylate, and copolymers of two or more of these. Further, in specific embodiments the 3D printed material may comprise one or more of acrylonitrile butadiene styrene, polystyrene, polycarbonate, modified PC with higher Tg (e.g. Apec from Covestro), polyethylene terephthalate, polymethylmethacrylate, polyethylene, polypropylene, and copolymers of two or more of these.

The (with the herein described method) obtained 3D printed item may be functional per se. The thus obtained 3D item may (alternatively) be used for decorative or artistic purposes. The 3D printed item may include or be provided with a functional component. The functional component may especially be selected from the group consisting of an optical component, an electrical component, and a magnetic component. The term “optical component” especially refers to a component having an optical functionality, such as a lens, a mirror, a light source (like a LED), etc. The term “electrical component” may e.g. refer to an integrated circuit, PCB, a battery, a driver, but also a light source (as a light source may be considered an optical component and an electrical component), etc. The term magnetic component may e.g. refer to a magnetic connector, a coil, etc. Alternatively, or additionally, the functional component may comprise a thermal component (e.g. configured to cool or to heat an electrical component). Hence, the functional component may be configured to generate heat or to scavenge heat, etc.

In yet a further aspect, the invention provides a luminaire or a lamp comprising the 3D item, such as e.g. a spot light or for a spot light. For instance, the item may be used as lamp shade, as housing for a lamp or as luminaire housing, such as a spot light etc.

Returning to the 3D printing process, a specific 3D printer may be used to provide the 3D printed item described herein. Therefore, in yet a further aspect the invention also provides a fused deposition modeling 3D printer, comprising (a) a printer head comprising a printer nozzle, and (b) a 3D printable material providing device configured to provide 3D printable material to the printer head, wherein the fused deposition modeling 3D printer is configured to provide said 3D printable material to a substrate, and build layer by layer the 3D item. The 3D printable material providing device may provide a filament comprising 3D printable material to the printer head or may provide the 3D printable material as such, with the printer head creating the filament comprising 3D printable material. Hence, in embodiments the invention provides a fused deposition modeling 3D printer, comprising (a) a printer head comprising a printer nozzle, and (b) a filament providing device configured to provide a filament comprising 3D printable material to the printer head, wherein the fused deposition modeling 3D printer is configured to provide said 3D printable material to a substrate, and build layer by layer the 3D item.

In specific aspects however, the 3D printed item may be provided as reflector, or (other) shaped body. In such embodiments, the substrate used has a shape of a reflector, or (other) shaped body, on which the layer has been provided first, and thereafter on the layer the 3D printed material has been provided. Therefore, the invention also provides a reflector or (other) shaped body, comprising a reflective surface, wherein the reflector or (other) shaped body, comprises the 3D printed item as defined herein, and wherein at least part of the reflective surface is provided by the 3D printed item.

Therefore, in specific embodiments of the method of the invention, the substrate has the shape of a reflector or (other) shaped body, with one or more of a curved face, a facetted face, and faces configured relative to each under an angle.

As indicated above, in embodiments the reflective surface comprises one or more of a curved face, a facetted face, and faces configured relative to each under an angle. In embodiments, the reflector is a collimator or a parabolic mirror. Hence, types of reflectors include but are not limited to ellipse shaped reflectors (e.g. for converging rays), parabola shaped reflectors (e.g. for making parallel rays), hyperbola-shaped reflectors (for diverging rays), etc.

The reflector may also be used in a lamp or luminaire.

Instead of the term “fused deposition modeling (FDM) 3D printer” shortly the terms “3D printer”, “FDM printer” or “printer” may be used. The printer nozzle may also be indicated as “nozzle” or sometimes as “extruder nozzle”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1b schematically depict some general aspects of the 3D printer and/or printing process;

FIG. 2a-2f schematically depict some aspects of embodiments of particles, with some of the shapes being depicted for reference purposes;

FIGS. 3a-3b schematically depict some further aspects of the invention; and

FIG. 4 schematically depicts a lamp or luminaire.

FIG. 5 shows examples of dollar shaped flakes;

FIG. 6-9 show results with such flakes;

FIG. 10 shows examples of corn-flake type of flakes; and

FIGS. 11-12 show results with such flakes.

The schematic drawings are not necessarily to scale.

### DETAILED DESCRIPTION OF THE EMBODIMENTS

FIG. 1a schematically depicts some aspects of the 3D printer. Reference 500 indicates a 3D printer. Reference 530 indicates the functional unit configured to 3D print, especially FDM 3D printing; this reference may also indicate the 3D printing stage unit. Here, only the printer head for providing 3D printed material, such as a FDM 3D printer head is schematically depicted. Reference 501 indicates the printer head. The 3D printer of the present invention may especially include a plurality of printer heads, though other embodiments are also possible. Reference 502 indicates a printer nozzle. The 3D printer of the present invention may especially include a plurality of printer nozzles, though other embodiments are also possible. Reference 321 indicates a filament of printable 3D printable material (such as indicated above). For the sake of clarity, not all features of the 3D printer have been depicted, only those that are of especial relevance for the present invention (see further also below).

The 3D printer 500 is configured to generate a 3D item 1 by layer-wise depositing on a receiver item 550, which may in embodiments at least temporarily be cooled, a plurality of filaments 321 wherein each filament 20 comprises 3D printable material, such as having a melting point Tₘ. The 3D printable material 201 may be deposited on a substrate 1550 (during the printing stage).

The 3D printer 500 is configured to heat the filament material upstream of the printer nozzle 502. This may e.g. be done with a device comprising one or more of an extrusion and/or heating function. Such device is indicated with reference 573, and is arranged upstream from the printer nozzle 502 (i.e. in time before the filament material leaves the printer nozzle 502). The printer head 501 may (thus) include a liquefier or heater. Reference 201 indicates printable material. When deposited, this material is indicated as (3D) printed material, which is indicated with reference 202.

Reference 572 indicates a spool or roller with material, especially in the form of a wire, which may be indicated as filament 320. The 3D printer 500 transforms this in a filament 321 downstream of the printer nozzle which becomes a layer 322 on the receiver item or on already deposited printed material. In general, the diameter of the filament 321 downstream of the nozzle is reduced relative to the diameter of the filament 322 upstream of the printer head. Hence, the printer nozzle is sometimes (also) indicated as extruder nozzle. Arranging layer 322 by layer 322 and/or layer 322t on layer 322, a 3D item 1 may be formed. Reference 575 indicates the filament providing device, which here amongst others include the spool or roller and the driver wheels, indicated with reference 576.

Reference A indicates a longitudinal axis or filament axis.

Reference C schematically depicts a control system, such as especially a temperature control system configured to control the temperature of the receiver item 550. The control system C may include a heater which is able to heat the receiver item 550 to at least a temperature of 50° C., but especially up to a range of about 350° C., such as at least 200° C.

Alternatively or additionally, in embodiments the receiver plate may also be moveable in one or two directions in the x-y plane (horizontal plane). Further, alternatively or additionally, in embodiments the receiver plate may also be rotatable about z axis (vertical). Hence, the control system may move the receiver plate in one or more of the x-direction, y-direction, and z-direction.

Layers are indicated with reference 322, and have a layer height H and a layer width W.

Note that the 3D printable material is not necessarily provided as filament 320 to the printer head. Further, the filament 320 may also be produced in the 3D printer 500 from pieces of 3D printable material.

FIG. 1b schematically depicts in 3D in more detail the printing of the 3D item 1 under construction. Here, in this schematic drawing the ends of the filaments 321 in a single plane are not interconnected, though in reality this may in embodiments be the case.

Hence, FIGS. 1a-1b schematically depict some aspects of a fused deposition modeling 3D printer 500, comprising (a) a first printer head 501 comprising a printer nozzle 502, (b) a filament providing device 575 configured to provide a filament 321 comprising 3D printable material 201 to the first printer head 501, and optionally (c) a receiver item 550. In FIGS. 1a-1b, the first or second printable material or the first or second printed material are indicated with the general indications printable material 201 and printed material 202. Directly downstream of the nozzle 502, the filament 321 with 3D printable material becomes, when deposited, layer 322 with 3D printed material 202.

FIG. 1b schematically depicts filaments have been deposited comprising particles. However, Not all layers need to include the particulate material, though this may of course be the case.

FIG. 2a schematically depicts for the sake of understanding particles and some aspects thereof. Note that the particles used in the present invention are especially elative flat, see e.g. FIG. 2d, 2e, FIG. 5, and FIG. 10.

The particles comprise a material 411, or may essentially consist of such material 411. The particles 410 have a first dimension or length L1. In the left example, L1 is essentially the diameter of the essentially spherical particle. On the right side a particle is depicted which has non spherical shape, such as an elongated particle 410. Here, by way of example L1 is the particle length. L2 and L3 can be seen as width and height. Of course, the particles may comprise a combination of differently shaped particles.

FIGS. 2b-2f schematically depict some aspects of the particles 410. Some particles 410 have a longest dimension A1 having a longest dimension length L1 and a shortest dimension A2 having a shortest dimension length L2. As can be seen from the drawings, the longest dimension length L1 and the shortest dimension length L2 have a first aspect ratio larger than 1. FIG. 2b schematically depicts a particle 410 in 3D, with the particle 410 having a length, height and width, with the particle (or flake) essentially having an elongated shape. Hence, the particle may have a further (minor or main) axis, herein indicated as further dimension A3. Essentially, the particles 410 are thin particles, i.e. L2<L1, especially L2<<L1, and L2<<L3. L1 may e.g. be selected from the range of 5-200 μm; likewise L3 may be. L2 may e.g. be selected from the range of 0.1-20 μm.

FIG. 2c schematically depicts a particle that has a less regular shape such as pieces of broken glass, with a virtual smallest rectangular parallelepiped enclosing the particle.

Note that the notations L1, L2, and L3, and A1, A2 and A3 are only used to indicate the axes and their lengths, and that the numbers are only used to distinguish the axis. Further, note that the particles are not essentially oval or rectangular parallelepiped. The particles may have any shape with at least a longest dimension substantially longer than a shortest dimension or minor axes, and which may essentially be flat. Especially, particles are used that are relatively regularly formed, i.e. the remaining volume of the fictive smallest rectangular parallelepiped enclosing the particle is small, such as less than 50%, like less than 25%, of the total volume.

FIG. 2d schematically depicts in cross-sectional view a particle 410 including a coating 412. The coating may comprise light reflective material. For instance, the coating may comprise a (white) metal oxide. In other embodiments, the coating may essentially consist of a metal, such as an Ag coating. In other embodiments the coatings may only be on one or both of the large surfaces and not on the thin side surfaces of the particles.

FIG. 2e schematically depicts a relatively irregularly shaped particle. The particulate material that is used may comprise e.g. small broken glass pieces. Hence, the particulate material that is embedded in the 3D printable material or is embedded in the 3D printed material may include a broad distribution of particles sizes. A rectangular parallelepiped can be used to define the (orthogonal) dimensions with lengths L1, L2 and L3.

FIG. 2f schematically depicts cylindrical, spherical, and irregularly shaped particles, which will herein in general not be used (see also above).

As shown in FIGS. 2b-2f the terms “first dimension” or “longest dimension” especially refer to the length L1 of the smallest rectangular cuboid (rectangular parallelepiped) enclosing the irregular shaped particle. When the particle is essentially spherical the longest dimension L1, the shortest dimension L2, and the diameter are essentially the same.

FIG. 3a schematically depicts a filament 321, such as when escaping from a printer nozzle (not depicted), which comprises 3D printable material 201. The 3D printable material comprise thermoplastic material 401 with particles 410 embedded therein.

FIG. 3b schematically depicts a 3D item 1, showing the ribbed structures (originating from the deposited filaments), having heights H. This height may also be indicated as width. Here, layers 322 with printed material 202, with heights H and widths W are schematically depicted. FIG. 3b can be seen as a stack of layers 322 of which a plurality adjacent stacks are shown in FIG. 1b.

FIG. 4 schematically depicts an embodiment of a lamp or luminaire, indicated with reference 1, which comprises a light source 10 for generating light 11. The lamp may comprise a housing or shade or other element, which may comprise or be the 3D printed item 2. The possible transmissivity of the material may provide additional optical effects and appearance (in the off state of the lamp or luminaire) may appear mat.

In experimental work, polycarbonate provided with aluminum dollar like flakes or coins with a size of 20 μm (1 μm thick) shown in FIG. 5. FIGS. 6-9 show the effect of layer thickness on the reflectivity of the direction perpendicular to the printed surface for respectively 0.2, 2, 10, and 20 wt % of the flakes, relative to the total weight (respectively 0.09, 0.9, 4.4, and 8.9 vol. %, relative to the total volume) of the PC-based 3D printable material (including the flakes). The diameter of the nozzle diameter of 1.8 mm which also corresponds to layer width was used to print the structures which were used in the reflectivity measurements shown in FIGS. 6-9.

Flakes of so called corn flakes type shown in FIG. 10 were also used. These flakes are 45 μm large flakes (1 μm thick). In FIG. 11 the side reflectivity of 3D printed PC containing about 1.4 wt. % is shown.

In FIG. 12 the side reflectivity of PC with such flakes at about 0.1 wt % (0.04 vol. %). Here, the sizes of the flakes are 20 μm largest length and only 30 nm thick. These flakes were obtained with physical vapor deposition.

The term “substantially” herein, such as “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention also provides a control system that may control the apparatus or device or system, or that may execute the herein described method or process. Yet further, the invention also provides a computer program product, when running on a computer which is functionally coupled to or comprised by the apparatus or device or system, controls one or more controllable elements of such apparatus or device or system.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

It goes without saying that one or more of the first (printable or printed) material and second (printable or printed) material may contain fillers such as glass and fibers which do not have (to have) influence on the on T_{g} or Tₘ of the material(s).

1. A method for 3D printing a 3D item, the method comprising the steps of:
providing a 3D printable material, and
layer-wise depositing the 3D printable material to provide the 3D item with layers of a 3D printed material,
wherein the 3D printable material comprises particles embedded in the 3D printable material at a particle concentration,
wherein the particles are metallic particles or particles coated with one or more of a metal coating and a metal oxide coating,
wherein each of the particles has a shape selected from the group of coin shapes and flake shapes, with a particle length (L1), a particle height (L2), and a first particle aspect ratio defined as the ratio of the particle length (L1) and the particle height (L2), the first particle aspect ratio being equal to or larger than 5,
wherein each layer of the 3D printed material has a layer height (H), a layer width (W) and a layer aspect ratio defined as the ratio of the layer width (W) and the layer height (H), and
wherein, when the layer aspect ratio is larger than 2, the particle concentration is in a range of 4-13 vol. % relative to the total volume of the 3D printable material, and when the layer aspect ratio is equal to or smaller than 2 and equal to or larger than 1, the particle concentration is in a range of 0.004-4% vol. % relative to the total volume of the 3D printable material.

2. The method according to claim 1, wherein, for at least 50 wt % of the particles, the particle length (L1) is in a range of 5-100 μm and the particle height (L2) is in a range of 0.1-20 μm, and wherein the layer height (H) is in a range of 0.05-5 mm.

3. The method according to claim 1, wherein the particles have a particle width (L3) in a range of 5-100 μm, wherein the particles have a second aspect ratio defined as the ratio of the particle width (L3) and the particle height (L2), and wherein the second particle aspect ratio is equal to or larger than 5.

4. (canceled)

5. The method according to claim 1, wherein each of the particles comprises one or more of a silver coating and an aluminum coating.

6. The method according to claim 1, wherein the 3D printable material comprises one or more of acrylonitrile butadiene styrene, polystyrene, polycarbonate, polyethylene terephthalate, polyethylene, polypropylene, polymethylmethacrylate, and copolymers of two or more of these.

7. The method according to claim 1, wherein the step of layer-wise depositing the 3D printable material to provide the 3D item with layers of a 3D printed material is performed with a fused deposition modeling 3D printer, wherein the fused deposition modeling 3D printer comprises a printer head, and wherein the printer head comprises a printer nozzle having an equivalent circular diameter that is larger than the particle length.

8. A 3D item comprising layers of a 3D printed material wherein the 3D printed material comprises particles embedded in the 3D printed material at a particle concentration, wherein the particles are metallic particles or particles coated with one or more of a metal coating and a metal oxide coating, wherein each of the particles has a shape selected from the group of coin shapes and flake shapes, with a particle length (L1), a particle height (L2), and a first particle aspect ratio defined as the ratio of the particle length (L1) and the particle height (L2), the first particle aspect ratio being equal to or larger than 5, wherein each layer of the 3D printed material has a layer height (H), a layer width (W) and a layer aspect ratio defined as the ratio of the layer width (W) and the layer height (H), and wherein the layer aspect ratio is larger than 2 and the particle concentration is in a range of 4-13 vol. % relative to the total volume of the 3D printable material, or the layer aspect ratio is equal to or smaller than 2 and equal to or larger than 1 and the particle concentration is in a range of 0.004-4% vol. % relative to the total volume of the 3D printable material.

9. The 3D item according to claim 8, wherein, for at least part of the total number of particles, the particle length (L1) is in a range of 5-200 μm and the particle height (L2) is in a range of 0.1-100 μm, and wherein the layer height (H) is in a range of 0.05-5 mm.

10. The 3D item according to claim 8, wherein, for at least 50 wt % of the particles, the particle length (L1) is in a range of 10-100 μm and the particle height (L2) is in a range of 0.1-20 μm, wherein the particles have a particle width (L3) in a range of 5-100 μm, wherein the particles have a second particle aspect ratio defined as the ratio of the particle width (L3) and the particle height (L2), wherein the second particle aspect ratio is equal to or larger than 5, and wherein the particles comprise one or more of a silver coating and an aluminum coating.

11. The 3D item according to claim 8, wherein the 3D printed material comprises one or more of acrylonitrile butadiene styrene, polystyrene, polycarbonate, polyethylene terephthalate, polyethylene, polypropylene, polymethylmethacrylate, and copolymers of two or more of these.

12. A luminaire or a lamp comprising the 3D item according to claim 8.
